(19) United States
(12) Patent Application Publication
(10) Pub. No.: US 2023/0251458 A1
(43) Pub. Date: Aug. 10, 2023

(54) INTERPUPILLARY DISTANCE ADJUSTMENT ASSEMBLIES, VR GLASSES, AND VR DEVICES

(71) Applicant: XIAMEN PINGJI QIANQIAN INFORMATION TECHNOLOGY CO., LTD., Xiamen (CN)

(72) Inventor: Rongyu CHEN, Xiamen (CN)

(73) Assignee: XIAMEN PINGJI QIANQIAN INFORMATION TECHNOLOGY CO., LTD., Xiamen (CN)

(21) Appl. No.: 18/301,433

(22) Filed: Apr. 17, 2023

Related U.S. Application Data
(63) Continuation-in-part of application No. PCT/CN2022/084939, filed on Apr. 1, 2022.
(63) Continuation-in-part of application No. PCT/CN2022/084940, filed on Apr. 1, 2022.

(30) Foreign Application Priority Data
Apr. 8, 2021 (CN) 202120715033.X
Apr. 29, 2021 (CN) 202120914023.9
Apr. 15, 2022 (CN) 202220871078.0

(51) Int. Cl. G02B 7/12; G09G 3/00; G06F 1/16

(52) U.S. Cl. CPC G02B 7/12; G06F 1/163; G09G 3/001; G06F 3/011

(57) ABSTRACT

The embodiment of the present disclosure provides an interpupillary distance adjustment assembly, VR glasses, and a VR device. The interpupillary distance adjustment assembly includes a left frame and a right frame, wherein an adjustable clip with an adjustable width is provided between the left frame and the right frame, and the adjustable clip is detachably connected to the left frame and the right frame, respectively.

### CROSS-REFERENCE TO RELATED APPLICATION

This application is a continuation-in-part application of International Patent Application PCT/CN2022/084940, filed on Apr. 1, 2022, which claims priority to Chinese Patent Application No. 202120715033.X, filed on Apr. 8, 2021. This application is a continuation-in-part application of International Patent Application PCT/CN2022/084939, filed on Apr. 1, 2022, which claims priority to Chinese Patent Application No. 202120914023.9, filed on Apr. 29, 2021. This application claims priority to Chinese Patent Application No. 202220871078.0, filed on Apr. 15, 2022. The contents of each of the above-related applications are hereby incorporated by reference.

### TECHNICAL FIELD

The present disclosure relates to the field of glasses, and in particular, to an interpupillary distance adjustment assembly, VR glasses, and a VR device.

### BACKGROUND

Virtual Reality is referred to as VR. Virtual reality head-mounted display equipment is referred to as VR glasses, which is a product that uses a variety of technologies such as simulation technology, computer graphics human-machine interface technology, multimedia technology, and network technology.

Interpupillary distances of different wearers are different. Although there are various kinds of VR glasses on the market, the interpupillary distance of the VR glasses has been set at the factory, and usually only a limited count of gears can be adjusted. The mismatch of the interpupillary distance may affect a comfort degree of a user when wearing it and reduce the user experience. Especially for the user with myopia, the mismatch of the interpupillary distance may make the user extremely prone to eye fatigue and other problems during long-term use.

Therefore, it is hoped that an interpupillary distance adjustment assembly, VR glasses, and a VR device can be provided to solve the problems of poor wearing comfort and poor user experience caused by the mismatch of the interpupillary distance.

### SUMMARY

One or more embodiments of the present disclosure provide an interpupillary distance adjustment assembly, VR glasses, and a VR device. The interpupillary distance adjustment assembly includes a left frame and a right frame, wherein an adjustable clip with an adjustable width is provided between the left frame and the right frame, and the adjustable clip is detachably connected to the left frame and the right frame, respectively.

In some embodiments, the adjustable clip is detachably connected to the left frame and the right frame through a matching structure of a protrusion and a groove.

In some embodiments, a limiting structure is provided between the protrusion and the groove; and the limiting structure includes a limiting cavity and a protruding portion matched with the limiting cavity.

In some embodiments, for each frame of the left frame and the right frame, an opaque cover is detachably provided on the frame, and a small hole is provided in a middle of the opaque cover.

In some embodiments, at least one first protruding hull protruding outward is provided on an edge of the frame, and the opaque cover is provided with a second protruding hull matched with the first protruding hull, and a magnetic adsorption part is placed in the first protruding hull and the second protruding hull; and the edge of the frame is also provided with a blocking rib.

In some embodiments, the edge of the frame is further provided with a third protruding hull protruding outward for connecting to an external lens.

In some embodiments, an outer wall of the frame is respectively provided with a connecting block protruding outward, and the connecting block is provided with a through hole, the adjustable clip includes a connecting rod, two ends of the connecting rod are provided with a support leg, and the support leg is inserted into the through hole.

In some embodiments, an installation groove is provided on an inner ring of the frame opposite to a side where the opaque cover is installed, and an inner wall of the installation groove is provided with a limiting protruding rib.

In some embodiments, a front end or a rear end of the left frame or the right frame is provided with a detachable additional frame.

In some embodiments, the front end or the rear end of the left frame or the right frame is provided with a magnetic adsorption part by setting a first installation groove; and the additional frame is provided with another magnetic adsorption part by setting a second installation groove corresponding to the first installation groove.

In some embodiments, the left frame or the right frame is provided with at least one fourth protruding hull on an edge of the frame, and the first installation groove is provided on the fourth protruding hull.

In some embodiments, an edge of the left frame or the right frame is provided with an arc-shaped blocking rib extending backward or forward.

In some embodiments, an isolation baffle is provided between the left frame and the additional frame, and between the right frame and the additional frame.

One or more embodiments of the present disclosure provide VR glasses. The VR glasses include a VR glasses body and the interpupillary distance adjustment assembly. The left frame and the right frame are detachably connected to a left eyepiece and a right eyepiece of the VR glasses, respectively. For the left frame and the left eyepiece, or for the right frame and the right eyepiece, the small hole on the opaque cover and an optical center on the eyepiece of the VR glasses body are located on a same straight line, and the straight line is perpendicular to the opaque cover and the eyepiece.

One or more embodiments of the present disclosure provide a VR device. The VR device includes VR glasses and the interpupillary distance adjustment assembly. The left frame and the right frame are detachably connected to a left eyepiece and a right eyepiece of the VR glasses, respectively.

In some embodiments, the adjustable clip includes a connection portion and an adjustment portion, the connection portion is located on both sides of the adjustment portion, and the connection portion is used to realize a detachable connection between the adjustable clip and the left frame, and between the adjustable clip and the right frame; and a cross-section of the adjustment portion is a C-shaped cross-section, the adjustment portion is provided with an abdicate cavity, the adjustment portion includes a rigid unit, a deformation connection unit, and a horizontal unit, the rigid unit and the horizontal unit are connected through the deformation connection unit to form the abdicate cavity, the horizontal unit is located on a top surface of the abdicate cavity, and the rigid unit is located on a side of the abdicate cavity.

In some embodiments, the VR device further includes an adjustment module, and the adjustment module includes a controller. The adjustment module further includes an interface assembly, a cover assembly, a frame assembly, and a driving device respectively communicated with the controller. The frame assembly includes an upper slide rail, a lower slide rail, a left push rod, a right push rod, a vertical rod, and a horizontal clamp; both ends of the left push rod and the right push rod are slidingly connected to the upper slide rail and the lower slide rail, respectively, and the left push rod and the right push rod are respectively connected to a left end portion and a right end portion of the adjustment portion; both ends of the vertical rod are respectively fixed on the upper slide rail and the lower rail, the horizontal clamp is slidingly provided on the vertical rod, and the horizontal clamp is used to fix the horizontal unit of the adjustment portion to maintain horizontal of the horizontal unit; and the interface assembly is used to connect the VR glasses, the cover assembly is used to heat the deformation connection unit of the adjustment portion, and the driving device is used to drive a sliding of the left push rod and the right push rod.

In some embodiments, the VR glasses include a processor. The processor is configured to: determine a width adjustment value of the adjustment portion based on the user feedback; and send the width adjustment value to the controller of the adjustment module through the interface assembly, and control the driving device to drive the sliding of the left push rod and the right push rod according to the width adjustment value based on the controller.

In some embodiments, the processor is further configured to: divide a binocular field of view of the VR glasses into a plurality of sub-regions based on a preset manner; display preset images sequentially in the plurality of sub-regions, and sequentially obtain the user feedback; and determine the width adjustment value of the adjustment portion based on the user feedback.

In some embodiments, the processor is further configured to: obtain a feedback feature by processing the user feedback into a preset format; and determine the width adjustment value by processing the feedback feature based on a width adjustment model, the width adjustment model being a machine learning model.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, wherein:

FIG. 1 is a first axonometric view of an interpupillary distance adjustment assembly according to some embodiments of the present disclosure;

FIG. 2 is a second axonometric view of the interpupillary distance adjustment assembly according to some embodiments of the present disclosure;

FIG. 3 is a first axonometric view of a left frame of the interpupillary distance adjustment assembly according to some embodiments of the present disclosure;

FIG. 4 is a first axonometric view of an adjustable clip of the interpupillary distance adjustment assembly according to some embodiments of the present disclosure;

FIG. 5 is a third axonometric view of the interpupillary distance adjustment assembly according to some embodiments of the present disclosure;

FIG. 6 is an axonometric view of a right frame of the interpupillary distance adjustment assembly according to some embodiments of the present disclosure;

FIG. 7 is a second axonometric view of the adjustable clip of the interpupillary distance adjustment assembly according to some embodiments of the present disclosure;

FIG. 8 is a fourth axonometric view of the interpupillary distance adjustment assembly according to some embodiments of the present disclosure;

FIG. 9 is a second axonometric view of the left frame of the interpupillary distance adjustment assembly according to some embodiments of the present disclosure;

FIG. 10 is a third axonometric view of the adjustable clip of the interpupillary distance adjustment assembly according to some embodiments of the present disclosure;

FIG. 11 is a fifth axonometric view of the interpupillary distance adjustment assembly according to some embodiments of the present disclosure;

FIG. 12 is a third axonometric view of the left frame of the interpupillary distance adjustment assembly according to some embodiments of the present disclosure;

FIG. 13 is a fourth axonometric view of the adjustable clip of the interpupillary distance adjustment assembly according to some embodiments of the present disclosure;

FIG. 14 is a sixth axonometric view of the interpupillary distance adjustment assembly according to some embodiments of the present disclosure;

FIG. 15 is a seventh axonometric view of the interpupillary distance adjustment assembly according to some embodiments of the present disclosure;

FIG. 16 is a front view of the interpupillary distance adjustment assembly according to some embodiments of the present disclosure;

FIG. 17 is a first axonometric view of a frame according to some embodiments of the present disclosure;

FIG. 18 is an axonometric view of a VR device according to some embodiments of the present disclosure;

FIG. 19 is a second axonometric view of the frame according to some embodiments of the present disclosure;

FIG. 20 is an eighth axonometric view of the interpupillary distance adjustment assembly according to some embodiments of the present disclosure;

FIG. 21 is a ninth axonometric view of the interpupillary distance adjustment assembly according to some embodiments of the present disclosure;

FIG. 22 is an axonometric view of the interpupillary distance adjustment assembly according to some embodiments of the present disclosure;

FIG. 23 is a schematic diagram of an adjustment portion according to some embodiments of the present disclosure; and

FIG. 24 is a schematic diagram of an adjustment module according to some embodiments of the present disclosure.

### DETAILED DESCRIPTION

The technical solutions of embodiments of the present disclosure will be more clearly described below, and the accompanying drawings need to be configured in the description of the embodiments will be briefly described below. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system”, “device”, “unit”, and/or “module” used herein are one method to distinguish different components, elements, parts, sections, or assemblies of different levels in ascending order. However, the terms may be displaced by other expressions if they may achieve the same purpose.

As shown in the present disclosure and claims, unless the context clearly prompts the exception, “a”, “one”, and/or “the” is not specifically singular, and the plural may be included. It will be further understood that the terms “comprise,” “comprises,” and/or “comprising,” “include,” “includes,” and/or “including,” when used in the present disclosure, specify the presence of stated steps and elements, but do not preclude the presence or addition of one or more other steps and elements thereof.

The flowcharts are used in present disclosure to illustrate the operations performed by the system according to the embodiment of the present disclosure. It should be understood that the front or rear operation is not necessarily performed in order to accurately. Instead, the operations may be processed in reverse order or simultaneously. Moreover, one or more other operations may be added to the flowcharts. One or more operations may be removed from the flowcharts.

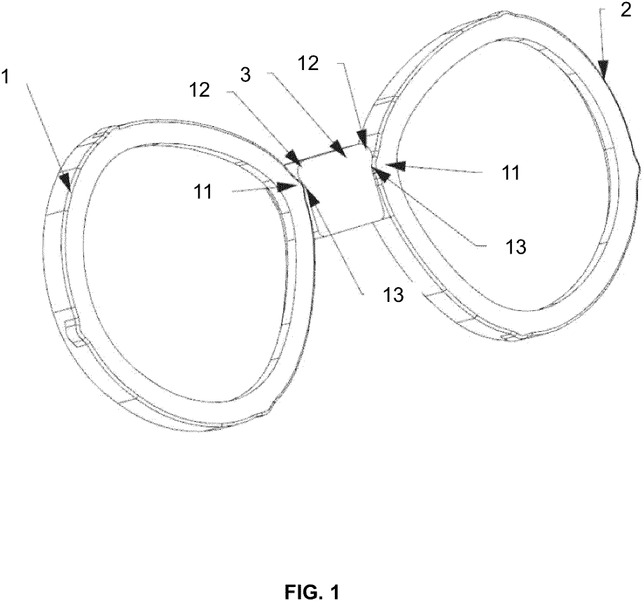

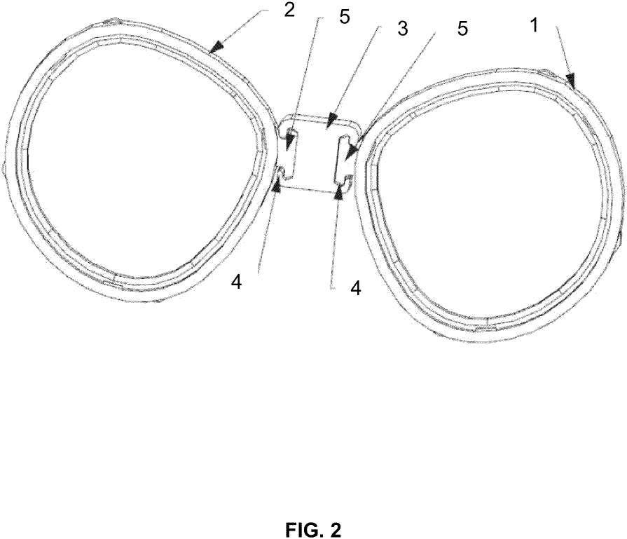

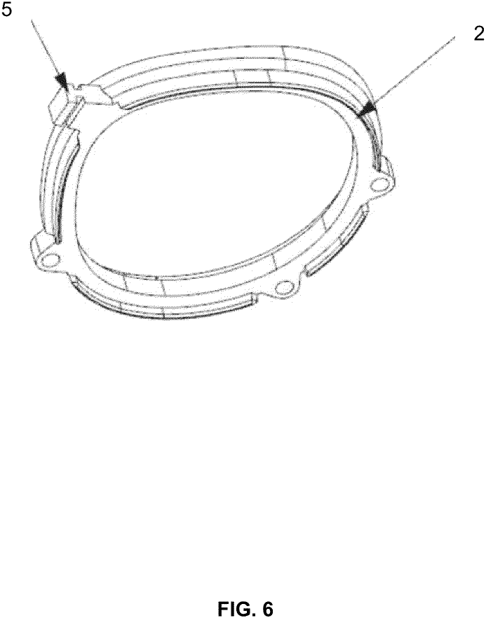

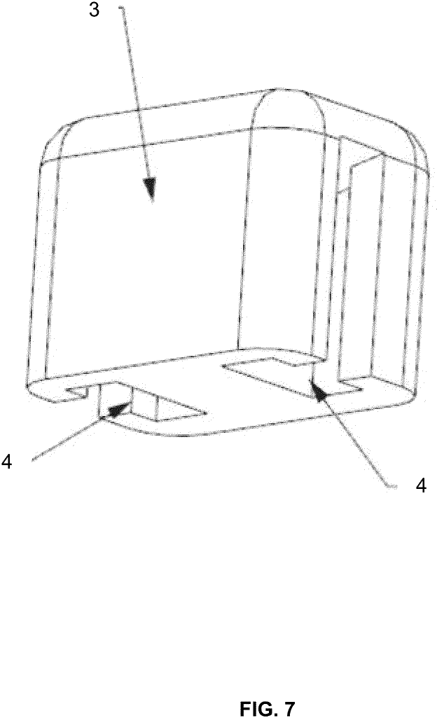

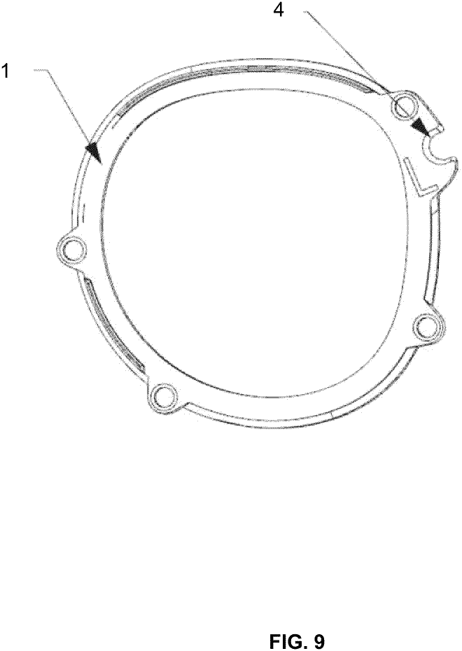

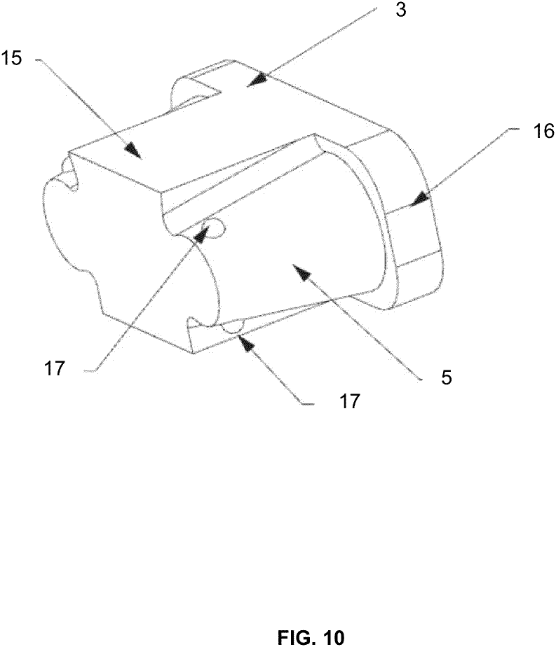

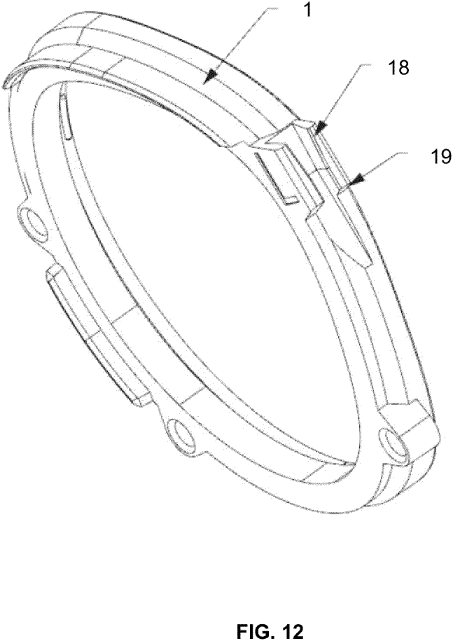

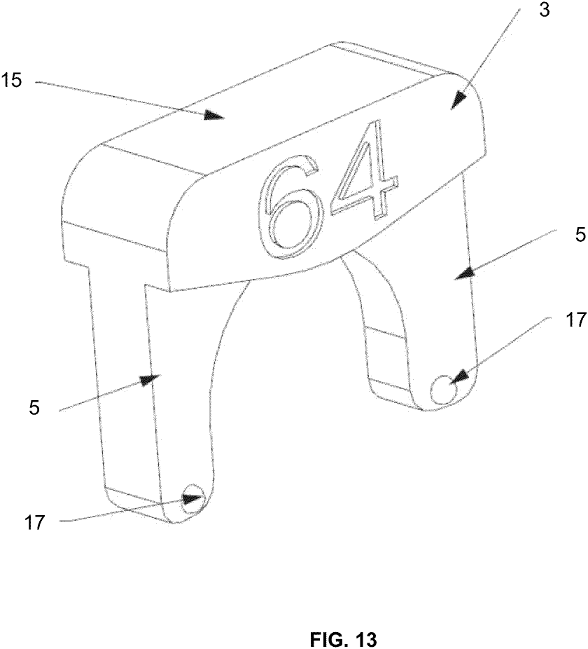

As shown in FIGS. 1-14, an interpupillary distance adjustment assembly provided by some embodiments of the present disclosure may include a left frame 1 and a right frame 2, and an adjustable clip 3 with an adjustable width is provided between the left frame 1 and the right frame 2.

The left frame 1 refers to a structure for installing a left eyepiece; and the right frame 2 refers to a structure for installing a right eyepiece. In some embodiments, the left frame 1 and the right frame 2 are symmetrically designed, and structural shapes of the left frame 1 and the right frame 2 are not limited, including but not limited to circle, ellipse, polygon, etc.

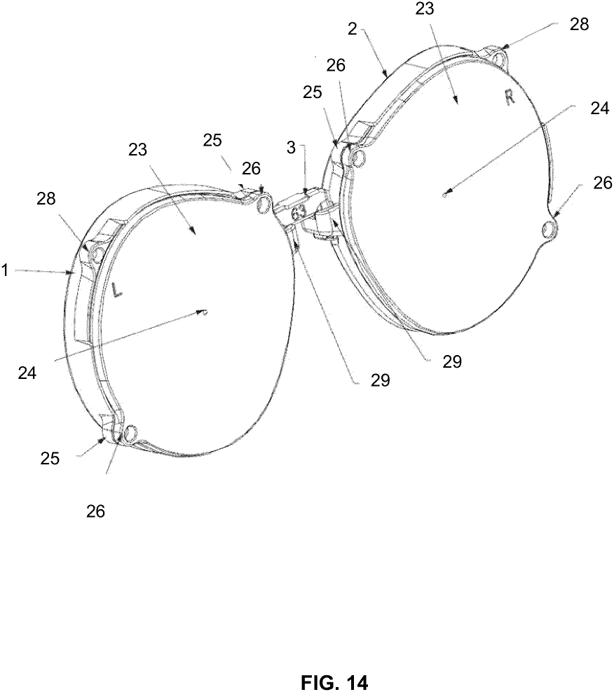

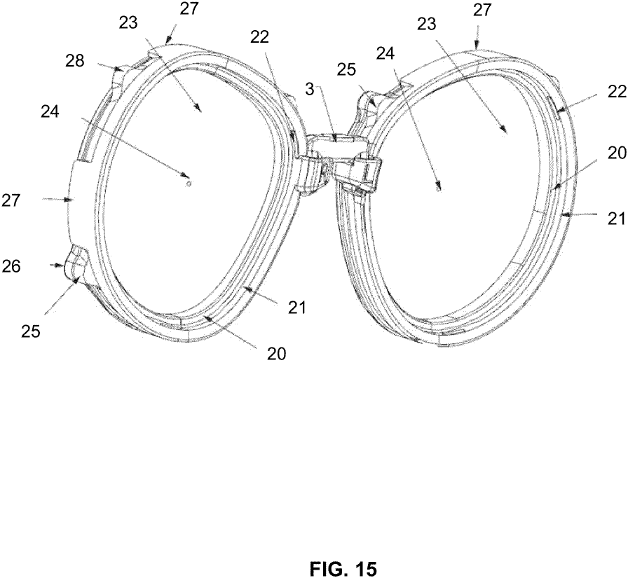

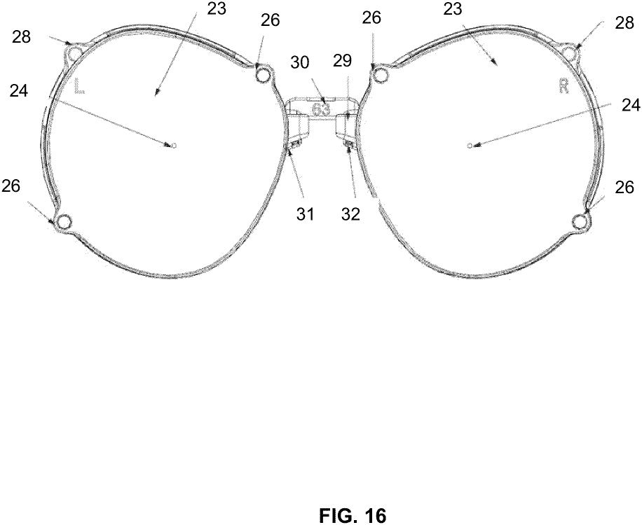

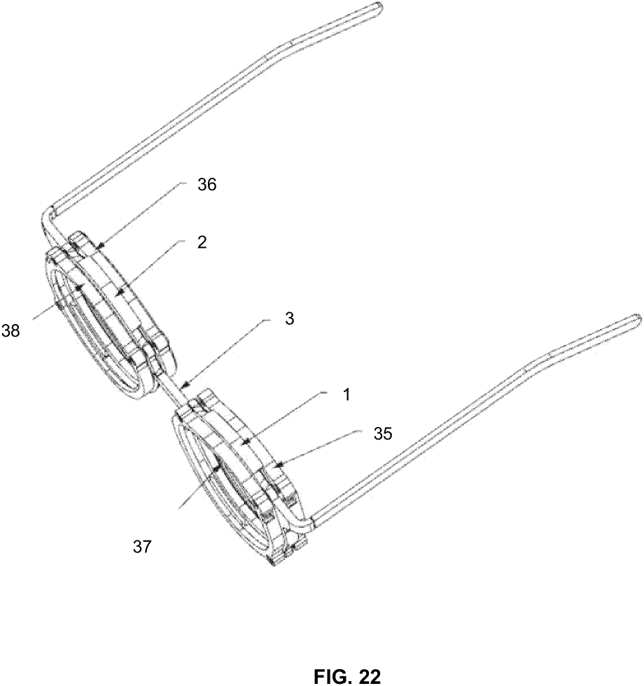

For more information about the left frame and the right frame, please refer to FIGS. 14-22 and related descriptions thereof.

The adjustable clip 3 refers to a structure for adjusting a distance between the left frame 1 and the right frame 2.

The adjustable clip 3 with an adjustable width may be realized in various ways. In some embodiments, the adjustable clip 3 may be a series of products with a plurality of sizes, or it may be customized according to an interpupillary distance of a wearer (that is, a user), and may be manufactured by 3D printing.

In some embodiments, the adjustable clip 3 may be a telescopic structure capable of adjusting the width in left and right directions. For example, the adjustable clip 3 may be a screw nut structure, a telescopic structure similar to a folding umbrella, or the like.

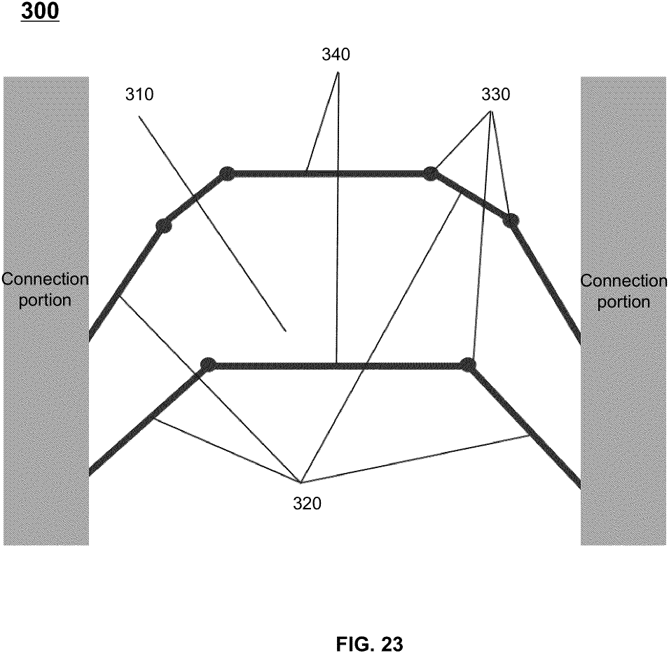

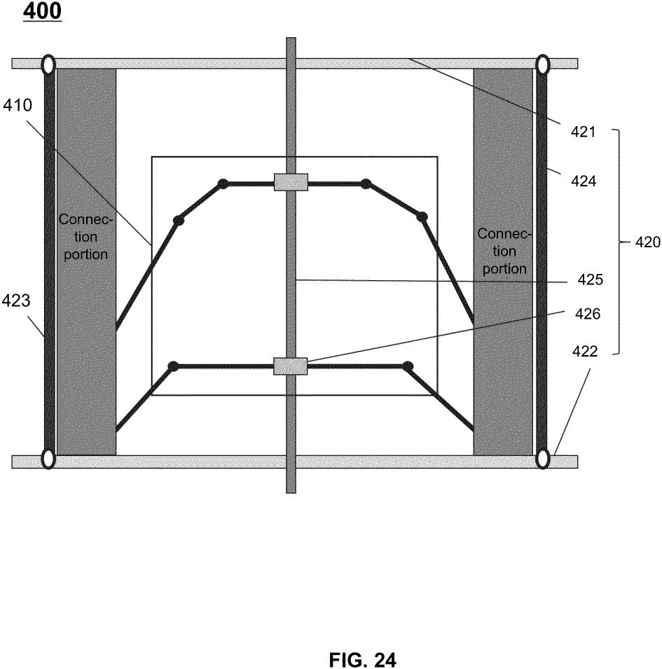

In some embodiments, the adjustable clip 3 may include a connection portion and an adjustment portion, and the width of the adjustable clip 3 may be adjusted by adjusting a width of the adjustment portion. For specific descriptions of the above content, please refer to FIGS. 23-24 and related descriptions thereof.

In some embodiments, the adjustable clips 3 may be detachably connected to the left frame 1 and the right frame 2, respectively. Adjustable clips 3 with different widths and different radians may be replaced through a detachable connection to adapt to different wearers, which can improve applicability and practicality of the interpupillary distance adjustment assembly.

In some embodiments, the detachable connection may be realized in various ways, including but not limited to magnetic adsorption, buckle connection, screw connection, or the like.

In some embodiments, the adjustable clip 3 may be detachably connected to the left frame 1 and the right frame 2 through a matching structure of a protrusion 5 and a groove 4.

As shown in FIGS. 1-7, a left side wall and a right side wall of the adjustable clip 3 are respectively provided with the groove 4 (that is, the groove 4 of the left side wall is formed by a concave of the left side wall toward the right, and the groove 4 of the right side wall is formed by a concave of the right side wall toward the left). A right outer wall of the left frame 1 and a left outer wall of the right frame 2 are respectively provided with the protrusion 5 that may be inserted into the groove 4. Through the matching between protrusion 5 and the groove 4, the adjustable clip 3 is connected to the left frame 1 and the right frame 2, and the width of the adjustable clip 3 determines a center distance between the left frame 1 and the right frame 2. The interpupillary distance between the left and right eyepieces installed on the left and right frames may be adjusted by adjusting the center distance.

In some embodiments, a limiting structure is provided between the protrusion 5 and the groove 4.

The limiting structure may be used to constrain a location of the adjustable clip 3 between the left frame 1 and the right frame 2. For example, an opening 6 is provided on an upper side, a lower side, a front side, or a rear side of the groove 4, and the protrusion 5 is inserted into the groove 4 through the limiting opening. In a state of wearing VR glasses, the front the wearer is the front side, the rear is the rear side, the upper is the upper side, and the lower is the lower side.

In some embodiments, the limiting structure may include a limiting cavity 7 and a protruding portion 9 matched with the limiting cavity 7. The limiting cavity 7 refers to a cavity for accommodating a protruding portion 9; and the protruding portion 9 refers to a structure used to be clamped in the limiting cavity 7, so that the left frame 1, the right frame 2, and the adjustable clip 3 may be connected.

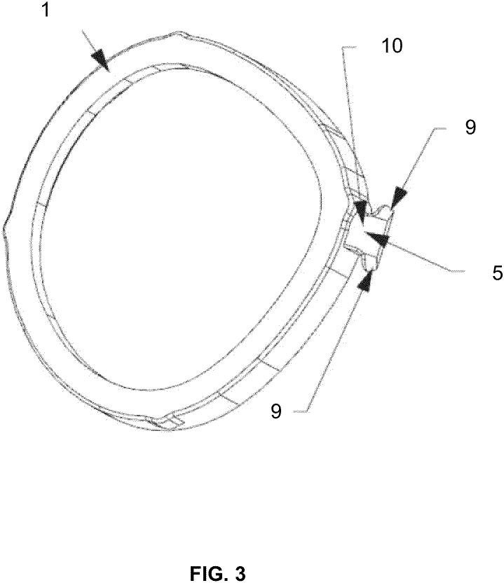

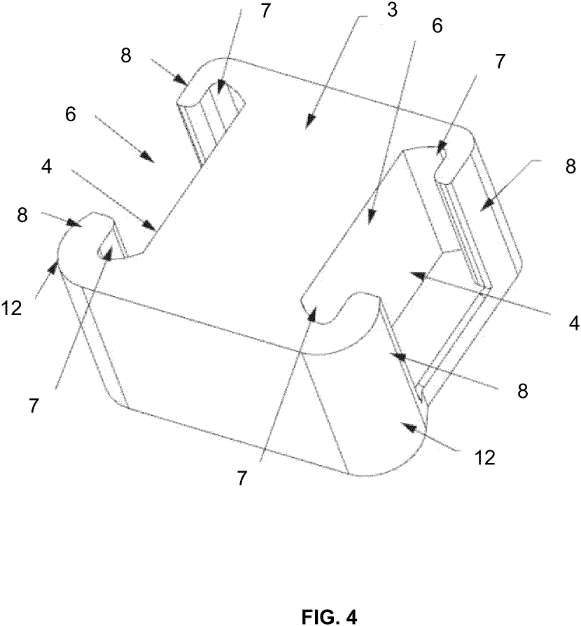

As shown in FIGS. 3-4, in order to facilitate the installation of the adjustable clip 3 and not affect the comfort of the wearer, the opening 6 may be disposed on the front side of the groove 4. The opposite side walls (that is, the upper and the lower of the wearer in the state of wearing) of the groove 4 are respectively provided with the limiting cavity 7 extending into the walls (that is, extending upward and downward). Due to the design of the limiting cavity 7, necessarily, there is a limiting wall 8 in a direction of the limiting cavity 7 toward the left frame or right frame, and the front side of the limiting cavity 7 is the opening 6 communicating with the groove 4. A protruding portion 9 matched with the limiting cavity 7 is provided on the protrusion 5. That is, the protruding portion 9 protruding outward is designed on the opposite sides (that is, the upper and the lower of the wearer in the state of wearing) of the protrusion 5.

In some embodiments, cross-sections of the groove 4 and the protrusion 5 include but not limited to a T-shaped structure. When the adjustable clip 3 is installed, the opening 6 of the groove 4 of the adjustable clip 3 is aligned with the protrusion 5, and the installation between the adjustable clip 3 and the left frame 1 and between the adjustable clip 3 and the right frame 2 may be realized by pressing from a rear-to-front direction of a wearing direction.

In some embodiments, the protrusion 5 is provided with a slope 10 that smoothly transitions from rear to front. Through a setting of the slope 10, it is easier to adjust the distance during the installation, and the installation is more convenient.

In some embodiments, the opposite side walls of the left frame 1 and the right frame 2 are respectively provided with a first positioning protruding hull 11, and an end of the left side wall and an end of the right side wall of the adjustable clip 3 are respectively provided with a second positioning protruding hull 12 matched with the positioning protruding hull 11. A recess 13 is formed at a joint between the second positioning protruding hull 12 and the side wall of the adjustable clip 3. During the installation, the first positioning protruding hull 11 is located under the second positioning protruding hull 12, that is, the first positioning protruding hull 11 is located at the recess 13. Through this setting, the reliability of the installation between the adjustable clip 3 and the left frame 1 and between the adjustable clip 3 and the right frame 2 can be improved, and displacement between the adjustable clip 3 and the left frame 1 and between the adjustable clip 3 and the right frame 2 can be avoided to affect the wearing comfort.

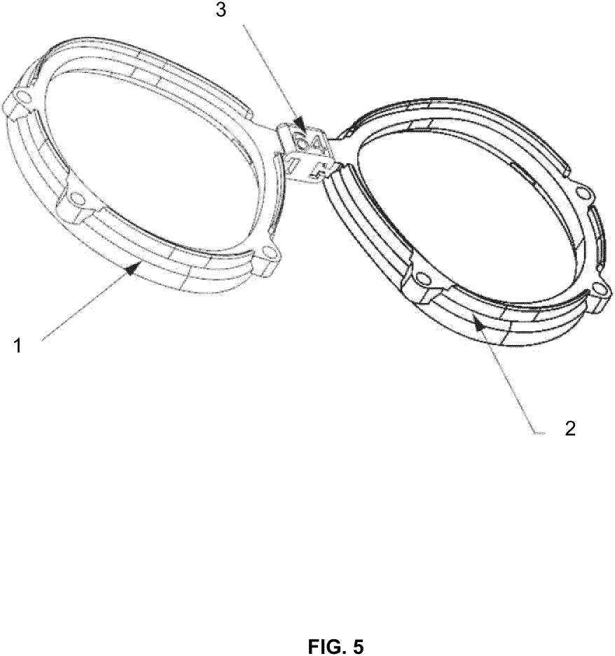

As shown in FIGS. 5-7, the opening 6 may also be disposed on a lower side of the groove 4. Likewise, the cross-sections of the groove 4 and the protrusion 5 include but not limited to a T-shaped structure. In some embodiments, the groove 4 on the adjustable clip 3 may be inserted into the protrusion 5 of the left frame 1 and the right frame 2 from upper to lower, so as to realize the connection between the adjustable clip 3 and the left frame 1 and between the adjustable clip 3 and the right frame 2.

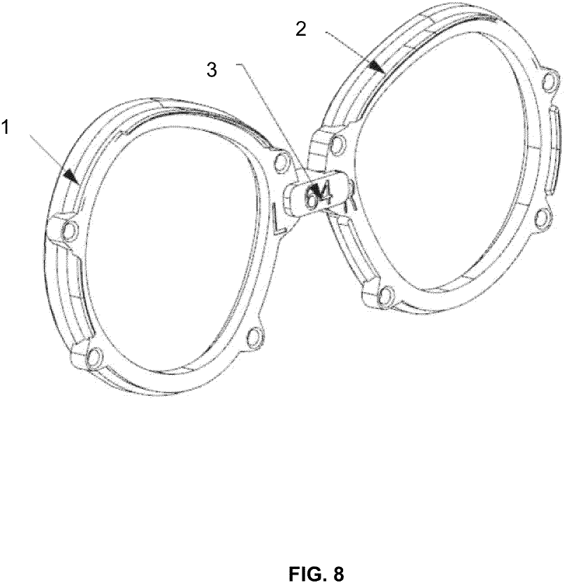

As shown in FIGS. 8-10, the left side wall and the right side wall of the adjustable clip 3 are respectively provided with the protrusion 5, and the right outer wall of the left frame 1 and the left outer wall of the right frame 2 are respectively provided with the groove 4 matched with the protrusion 5. Through the matching between the protrusion 5 and the groove 4, the connection between the adjustable clip 3 and the left frame 1 and between the adjustable clip 3 and the right frame 2 are realized.

In some embodiments, both the protrusion 5 and the groove 4 may be disposed along a front-to-rear direction (that is, the front and rear of the wearer in the state of wearing).

In some embodiments, the adjustable clip 3 may include a main body 15. The main body 15 may be understood as a substrate of the adjustable clip 3.

In some embodiments, the left and right sides of the main body 15 are provided with the protrusion 5, a thickness of the protrusion 5 is smaller than a thickness of the main body 15, and a rear side of the protrusion 5 and the main body 15 is provided with a cover 16. A width (i.e., a distance from left to right) of the cover 16 is greater than a sum of a width of the main body 15 and a width of the protrusion 5, and the thickness of the cover 16 is equal to the thickness of the main body 15. The cross-section of the protrusion 5 may be square, polygonal, circular, semicircular, etc. In some embodiments, the cross-sections of the protrusion 5 and the groove 4 are both semicircular.

In some embodiments, the groove 4 is a groove that runs through front and rear, and a length (i.e., a distance from front to rear) of the protrusion 5 is greater than a length of the groove 4. In some embodiments, the front outer wall of the protrusion 5 is provided with a limiting protruding nail 17.

The limiting protruding nail 17 refers to a structure for constraining the relative movement between the protrusion 5 and the groove 4. The limiting protruding nail 17 and the protrusion 5 may be of an integral structure, or may be a separate structure (e.g., the limiting protruding nail 17 may be disposed on the protrusion 5 based on welding, bonding, or other manners). In some embodiments, after the installation is completed, the limiting protruding nail 17 is located outside the groove 4. Constraining the protrusion 5 and the groove 4 by the limiting protruding nail 17, the adjustable clip 3 can be prevented from falling out from the groove 4 during use.

In some embodiments, both the groove 4 and the protrusion 5 have a forward slope. That is, the cross-sectional areas of the protrusion 5 and the groove 4 gradually decrease from rear to front. In addition, rounded corners are provided at both corners of the protrusion 5 and both ends of the groove 4.

During the installation, by putting the adjustable clip 3 from the rear to front, the protrusion 5 on the adjustable clip 3 is inserted into the groove 4 of the left frame 1 and the right frame 2. After the installation is in place, the cover 16 of the adjustable clip 3 is contacted to substrates of the left frame 1 and the right frame 2, and constrains the adjustable clip 3 from sliding out through the limiting protruding nail 17. Moreover, the slope of the groove 4 is matched with the slope of protrusion 5 to facilitate the installation.

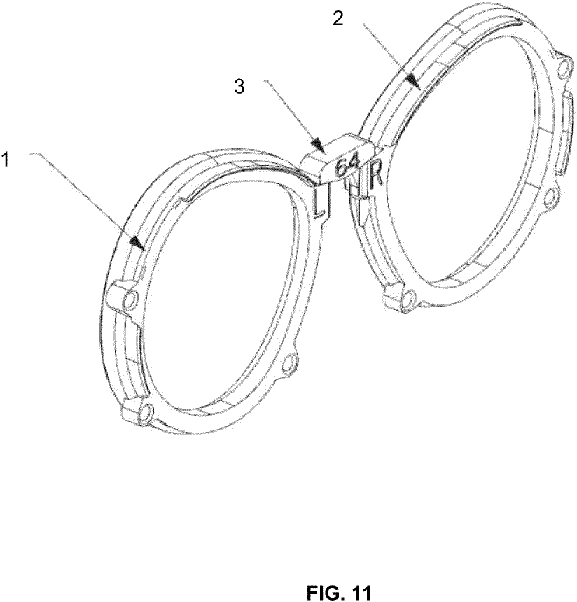

As shown in FIGS. 11-13, the protrusion 5 and the groove 4 may also be disposed along an up-to-down direction (e.g., the upper and lower of the wearer in the state of wearing). The adjustable clip 3 includes the main body 15. Two protrusions 5 extending downward are respectively disposed on left and right bottoms of the main body 15, and the two protrusions 5 are separately disposed.

Likewise, the cross-section of the protrusion 5 may be square, polygonal, circular, semicircular, etc. In some embodiments, the cross-sections of the protrusion 5 and the groove 4 are both trapezoidal.

In some embodiments, the groove 4 is a groove that runs through the upper and lower, and a height of the protrusion 5 is greater than that of the groove 4. In some embodiments, the lower outer wall of the protrusion 5 is provided with the limiting protruding nail 17 to prevent the adjustable clip 3 from falling out from the groove 4 during use.

In some embodiments, a cavity of the groove 4 is divided into an upper cavity 18 and a lower cavity 19, there is a slope in an inner wall of the upper cavity 18 and a cross-sectional area of the upper cavity 18 becomes smaller from upper to lower. An inner wall of the lower cavity 19 is a vertical straight plane, and a cross-sectional area of the lower cavity 19 is consistent with a minimum cross-sectional area of the upper cavity 18 and remains unchanged. The front and rear sides of the protrusion 5 are also provided with an inward slope, that is, the thickness of the protrusion 5 gradually decreases from upper to lower, and the thickness of the bottom side of the protrusion 5 is not greater than a width (a distance from front to rear) of the lower cavity 19 of the groove 4, the limiting protruding nails 17 are respectively disposed on the front and rear sides of the lower side of the protrusion 5.

During the installation, by putting the adjustable clip 3 from the upper to lower, the protrusion 5 on the adjustable clip 3 is inserted into the groove 4 of the left frame 1 and the right frame 2. After the installation is in place, the main body 15 of the adjustable clip 3 is contacted to the substrates of the left frame 1 and the right frame 2, and constrains the adjustable clip 3 from sliding out through the limiting protruding nail 17. Moreover, through the slope provided in the upper cavity 18 of the groove 4, the installation can be performed more conveniently.

It should be noted that the adjustable clip 3 may be detachably connected to the left frame 1 and the right frame 2 based on other structures, which is not limited in the present disclosure. For example, a screw connection structure may be adopted.

In some embodiments of the present disclosure, the adjustable clip is detachably connected to the left frame and the right frame, which make the installation manner convenient and quick. The distance between the left frame and the right frame is adjusted based on the adjustable clip, and then the interpupillary distance is adjusted to suit each wearer, so as to improve the wearing comfort. In addition, the detachable connection is realized by using the matching of the protrusion and the groove, and the limiting structure is set between the protrusion and the groove, which can ensure a close connection of the adjustable clip and the left and right frames. This design has a simple structure, less difficulty in processing, and a low cost.

As shown in FIGS. 14-16, the left frame 1 and the right frame 2 may be annular frames sleeved on the left eyepiece and the right eyepiece, respectively.

In some embodiments, for each frame of the left frame 1 and the right frame 2, an opaque cover 23 is detachably provided on the frame, and a small hole 24 is provided in a middle of the opaque cover 23.

In some embodiments, a shape of the opaque cover 23 is basically consistent with a shape of an eyepiece lens, and an opening location of the small hole 24 on the opaque cover 23 is consistent with a location of an optical center on the eyepiece lens. Therefore, for the left frame 1 and the left eyepiece, or for the right frame 2 and the right eyepiece, when the frame is installed on the eyepiece, the small hole 24 on the opaque cover 23 on the frame and the optical center on the eyepiece are respectively located on a same straight line, and the straight line is perpendicular to the opaque cover and the eyepiece.

In some embodiments, there are various ways to assemble the opaque cover 23 with the frame. For example, the opaque cover 23 may be assembled with the frame based on a buckle connection, a screw connection, etc.

In some embodiments, the opaque covers 23 and the left frame 1 and the right frame 2 may be magnetically adsorbed. For example, the edges of the left frame 1 and the right frame 2 are respectively provided with at least one first protruding hull 25 protruding outward, and the opaque cover 23 is provided with a second protruding hull 26 matched with the first protruding hull 25.

The first protruding hull 25 refers to a protruding structure disposed on the left and right frames. In some embodiments, a count of the first protruding hulls 25 is not limited, and it may be determined based on historical data, experiments, or the like.

The second protruding hull 26 refers to a protruding structure disposed on the opaque cover 23 and matched with the first protruding hull 25. In some embodiments, the structure and count of the second protruding hull 26 may be the same as the structure and count of the first protruding hull 25.

In some embodiments, a magnetic adsorption part is placed inside the first protruding hull 25 and the second protruding hull 26. The magnetic adsorption part refers to a magnetic part, including but not limited to a magnet.

In some embodiments, the edges of the left frame 1 and the right frame 2 may also be provided with a blocking rib 27.

The blocking rib 27 refers to a strip-like structure protruding axially upward from the edge of the frame. In some embodiments, a count of the blocking ribs 27 is not limited, and the blocking ribs 27 provided on the left frame 1 and the right frame 2 may be one or more.

For example, the first protruding hull 25 is provided on both sides of the blocking rib 27, and the second protruding hull 26 matched with the first protruding hull 25 is provided on the opaque cover 23, the first protruding hull 25 and the second protruding hull 26 are provided with grooves, magnetic adsorption parts (such as magnets, etc.) are installed in the grooves, and the opposite sides of the magnetic adsorption parts in the grooves of the first protruding hull 25 and the second protruding hull 26 are different poles. The installation of the opaque cover 23 and the left and right frames may be realized through the adsorption of the magnetic adsorption parts in the first protruding hull 25 and the second protruding hull 26. In addition, through the blocking rib 27, not only location guidance of the opaque cover 23 can be realized, so that the small hole 24 on the opaque cover 23 faces the optical center of the eyepiece after the opaque cover 23 is installed, but also the slipping of the opaque cover 23 relative to the frame during operation can be avoided.

As shown in FIGS. 14-16, the edges of the left frame 1 and the right frame 2 may also be provided with a third protruding hull 28 protruding outward for connecting to an external lens.

The external lens refers to a lens that is externally installed on the eyepiece lens, including but not limited to a lens for myopia glasses.

In some embodiments, the third protruding hull 28 is also provided with a groove, and a magnetic adsorption part is also disposed in the groove. The magnetic adsorption part is used for a detachable connection with the external lens installed with another magnetic adsorption part.

In some embodiments, an outer wall of the left frame 1 and an outer wall of the right frame 2 are respectively provided with a connecting block 29 protruding outward, and the connecting block 29 is provided with a through hole, the adjustable clip 3 includes a connecting rod 30, two ends of the connecting rod are provided with a support leg 31, and the support leg 31 is inserted into the through hole.

In some embodiments, the connecting rod 30 is provided with scales or dimensional values, and the scales or dimensional values may be determined based on simulations, experiments, or the like.

In this way, the adjustable clip 3 is Π-shaped, and the support leg 31 of the adjustable clip 3 is provided with a limiting protruding portion 32, so that the adjustable clip 3 may be prevented from falling out from the through hole of the connecting block 29. The limiting protruding portion 32 may be designed in various structures, and it may only need to prevent the adjustable clip 3 from falling out from the through hole of the connecting block 29.

In some embodiments, an installation groove 21 is provided on an inner ring of the left frame 1 and the right frame 2 opposite to a side where the opaque cover 23 is installed, and an inner wall of the installation groove 21 is provided with a limiting protruding rib 22.

In some embodiments, an inner wall of a ring frame of the left frame 1 and the right frame 2 has a step 20, and the inner wall with a larger inner diameter on one side of the step 20 forms the installation groove 21 with the step 20, and the installation groove 21 may be set on the left and right eyepiece. Further, the limiting protruding rib 22 is provided on the inner wall of the installation groove 21, and a limiting groove matched with the limiting protruding rib 22 may also be provided on the left and right eyepieces. When the left and right frames are installed on the left and right eyepieces, the axial movement of the left and right frames may be limited by the step 20, and the circumferential movement of the left and right frames may be limited by the matching of the limiting protruding rib 22 and the limiting groove.

In some embodiments of the present disclosure, the eyepiece can be adjusted to a location suitable for the interpupillary distance of the wearer simply, quickly, conveniently, and accurately by using the interpupillary distance adjustment assembly; moreover, the opaque cover can achieve a purpose of protecting the eyepiece from dust, scratches, and ultraviolet radiation to a certain extent.

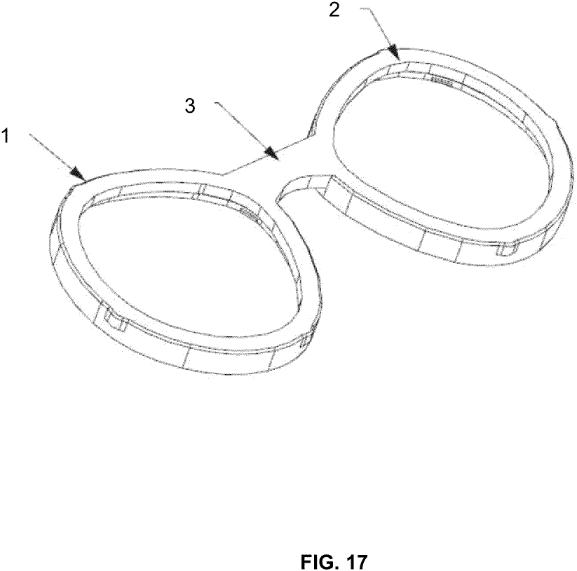

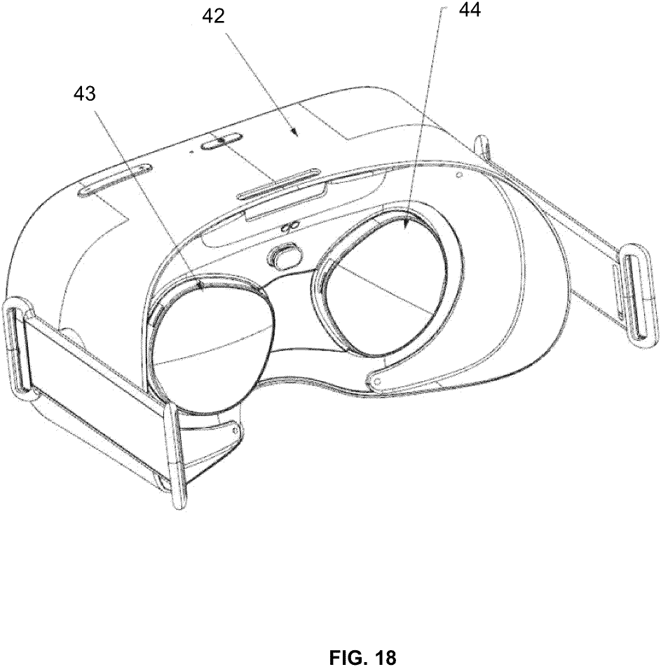

As shown in FIGS. 17-18, some embodiments of the present disclosure provide VR glasses, which include a VR glasses body 42 and the aforementioned interpupillary distance adjustment assembly.

The VR glasses body 42 refers to a substrate of the VR glasses. As shown in FIG. 18, the VR glasses body 42 may include a left eyepiece 43 and a right eyepiece 44. In some embodiments, the left frame 1 and the right frame 2 are detachably connected to the left eyepiece 43 and the right eyepiece 44 of the VR glasses body 42, respectively.

As shown in FIGS. 14-16, opaque covers 23 are detachably installed on the left frame 1 and the right frame 2, respectively, and small holes 24 are respectively provided in the middle of the two opaque covers 23. In some embodiments, for the left frame 1 and the left eyepiece 43, or for the right frame 2 and the right eyepiece 44, the small hole 24 on the opaque cover 23 and the optical center of the eyepiece of the VR glasses body 42 are located on the same line, and the line is perpendicular to the opaque cover 23 and the eyepiece.

When adjusting the distance between the eyepieces of the VR glasses based on the interpupillary distance adjustment assembly provided by some embodiments of the present disclosure, the left frame 1 and the right frame 2 with the opaque cover 23 are installed on the left eyepiece and the right eyepiece of the VR glasses, respectively, for the left frame 1 and the left eyepiece, or for the right frame 2 and the right eyepiece, the small hole 24 on the opaque cover 23 on the frame is on the same line as the optical center of the eyepiece of the VR glasses, and the line is perpendicular to the opaque cover 23 and the eyepiece. During detection and adjustment, the wearer’s eyes can see through the small holes 24 on the opaque covers 23 that before adjustment, the fields of view seen by both eyes are likely to be non-overlapping. By adjusting the distance between the left and right eyepieces, the fields of view seen by both eyes of the wearer may overlap. When the fields of view overlap, the optical centers of the left eyepiece 43 and the right eyepiece 44 of the VR glasses, the small holes 24, and the interpupillaries of the wearer’s eyes are on the same straight line. Finally, the adjustable clip 3 is used to be detachably connected to the left frame 1 and the right frame 2, and then the opaque cover 23 is removed, so that the VR glasses can be experienced with a correct eyepiece distance, and the user experience can be improved.

In some embodiments of the present disclosure, based on the principle of pinhole imaging, the interpupillary distances between the eyes of different users are detected, and the distance between the left and right eyepieces is adjusted by continuously moving the left and right eyepieces, and the adjustable clip is used to limit the distance between the left frame and the right frame, which can make the distance between the left and right eyepieces fixed in a plurality of different locations to be suitable for different VR glasses wearers, so that the wearers can use the VR device more comfortably. By setting the opaque covers, the eyepieces of the VR glasses in a non-use state can be protected, so as to prolong the service life of the eyepieces.

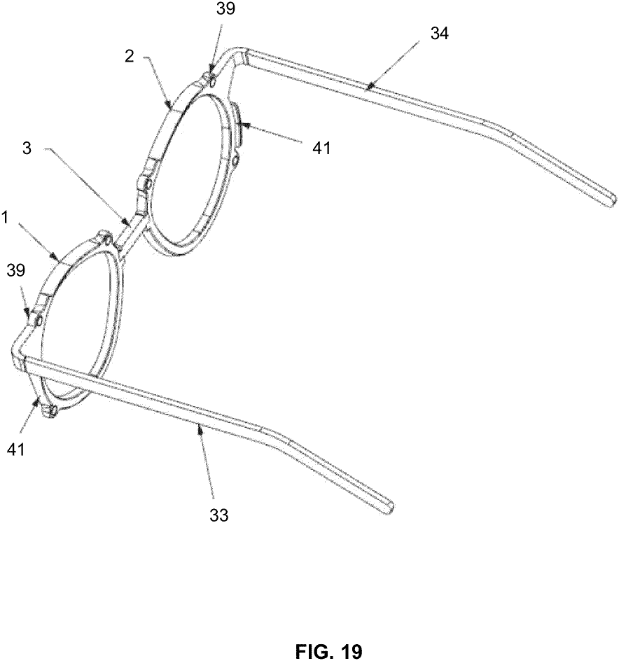

As shown in FIGS. 19-22, the left edge of the left frame 1 is provided with a left support leg 33 extending backward, and the right edge of the right frame 2 is provided with a right support leg 34 extending backward.

In some embodiments, a front or rear end of the left frame 1 or the right frame 2 is provided with a detachable additional frame. In some embodiments, based on different installation locations, the additional frame may include a left rear additional frame 35, a right rear additional frame 36, a left front additional frame 37, and a right front additional frame 38.

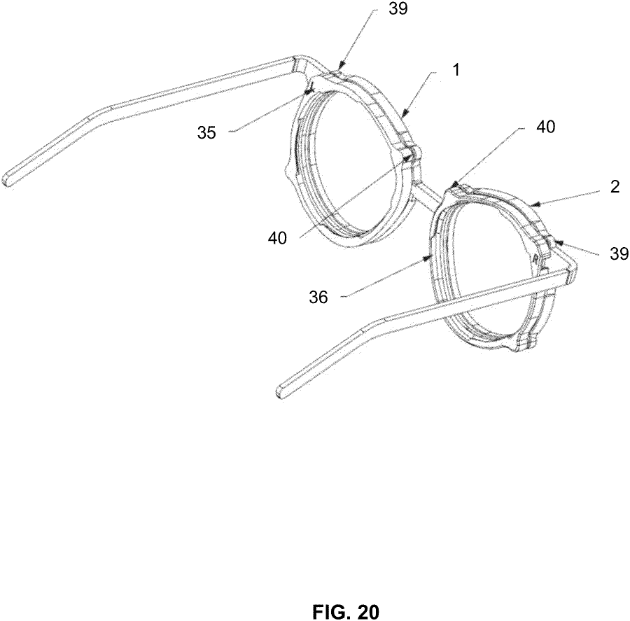

As shown in FIGS. 19-20, the left rear additional frame 35 may only be installed on the rear end of the left frame 1, or the right rear additional frame 36 may only be installed on the rear end of the right frame 2, or the left rear additional frame 35 may be installed on the rear end of the left frame 1, and the right rear additional frame 36 may be installed on the rear end of the right frame 2 simultaneously.

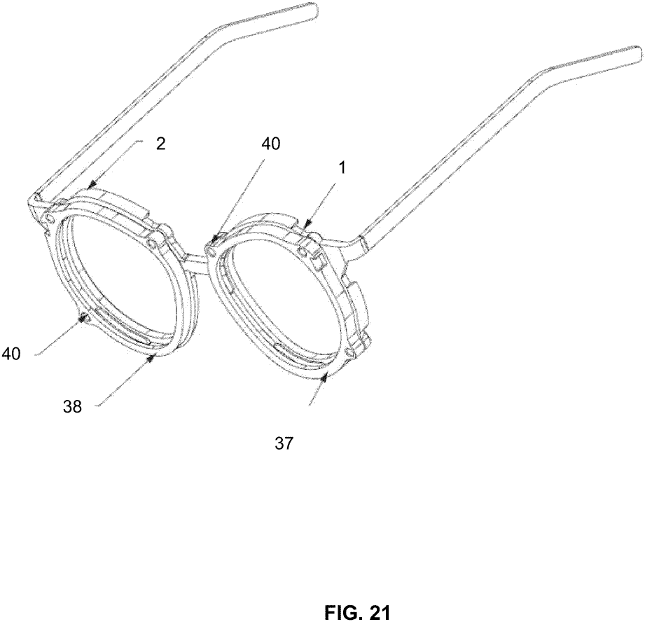

As shown in FIGS. 19 and 21, the left front additional frame 37 may only be installed on the front end of the left frame 1, or the right front additional frame 38 may only be installed on the front end of the right frame 2, or the left front additional frame 37 is installed on the front end of the left frame 1, and the right front additional frame 38 is installed on the front end of the right frame 2 simultaneously.

As shown in FIGS. 19 and 21, a detachable front additional frame may also be provided on the front end of the left frame 1 or right frame 2, and a detachable rear additional frame may be provided on the rear end of the left frame 1 or right frame 2.

In some embodiments, it is also possible to set an additional frame only on the front end or rear end of one side of the left frame 1 or right frame 2, or to set additional frames on the front end or rear end of both sides of the left frame 1 and the right frame 2, or to set additional frames on the front end and rear end of the left and right frames at the same time. The specific setting manner of the additional frame may be selected by the wearer according to actual needs.

As shown in FIGS. 19-22, the additional frame has a profile matched with the left frame 1 or right frame 2. For example, the left rear additional frame 35 has substantially the same profile as the left frame 1, and the right rear additional frame 36 has substantially the same profile as the right frame 2.

In some embodiments, there is no limit to how the additional frame is connected to the left and right frames. For example, the connection manner may be convenient for loading and unloading, such as bonding, screw connection, buckle connection, or magnetic adsorption. Preferably, the connection may be made by means of magnetic adsorption, so that the wearer may arbitrarily add additional frames based on actual needs.

As shown in FIGS. 17-20, the front end or rear end of the left frame 1 or the right frame 2 may be provided with a magnetic adsorption part by setting a first installation groove, and the additional frame is provided with another magnetic adsorption part by setting a second installation groove corresponding to the first installation groove.

In some embodiments, at least one first installation groove may be provided on the front end or the rear end of the left frame 1 or the right frame 2 along the circumference of the frame for installing the magnetic adsorption part (such as magnets, etc.). Similarly, at least one second installation groove may be correspondingly provided on the rear end or the front end of the additional frame for installing the another magnetic adsorption part.

It should be noted that there is no limit to the count of the first installation grooves and the second installation grooves, which may be determined based on experiments, simulations, etc., as long as the additional frame can be closely connected to the left and right frames.

As shown in FIGS. 19-22, the left frame 1 or the right frame 2 is provided with at least one fourth protruding hull 39 along the edge of the frame, and the first installation groove is provided on the fourth protruding hull 39.

Specifically, the left frame 1 and the right frame 2 are respectively provided with three fourth protruding hulls 39 protruding outward along the edges of the frames, and fifth protruding hulls 40 corresponding to the fourth protruding hulls 39 are disposed on the edge of the additional frame, the first installation groove is disposed on the fourth protruding hulls 39, and the second installation groove is disposed on the fifth protruding hull 40. The installation and removal of the left and right frames and the additional frame may be realized through the adsorption of the magnetic adsorption parts (such as magnets, etc.) in the first installation groove and the second installation groove.

Further, the fourth protruding hulls 39 may be respectively disposed on the edges of the left and right frames. For example, two fourth protruding hulls 39 may be disposed on the left and right sides of the top of the left frame 1, and another fourth protruding hull 39 is disposed on the left lower part of the left frame 1; and fourth protruding hulls 39 on the right frame are disposed at symmetrical locations with the fourth protruding hulls 39 on the left frame 1. With this setting, a more stable fit between the left and right frames and the additional frame can be achieved through three-point fixation, and the location can be fixed more accurately. In addition, the location setting of the fourth protruding hull 39 and the fifth protruding hull 40 on the frame can be more aesthetically pleasing and fashionable.

It should be noted that the additional frame may be closely connected to the left frame 1 and the right frame 2 by setting other structures, which is not limited in the present disclosure.

In some embodiments, the edge of the left frame 1 or the right frame 2 is also provided with an arc-shaped blocking rib 41 extending backward or forward.

The arc-shaped blocking rib 41 refers to a structure for adjusting the installation location of the additional frame. In some embodiments, the arc-shaped blocking rib 41 may be divided into a left arc-shaped blocking rib and a right arc-shaped blocking rib. The left arc-shaped blocking rib is disposed on the edge of the left frame 1; the right arc-shaped blocking rib is disposed on the edge of the right frame 2.

In some embodiments of the present disclosure, through the setting of the left and right arc-shaped blocking ribs, after the additional frame is installed on the left and right frames, the installation location of the additional frame may be adjusted based on the left arc-shaped rib and the right arc-shaped rib, so as to ensure that the optical centers of the left frame, the right frame, and the additional frame are at the same point.

In some embodiments, an isolation baffle is also provided between the left frame 1 and the right frame 2. The isolation baffle is clamped by a two-layer spectacle frame, and the isolation baffle covers part of the entire face of the wearer, which can improve the protection of the face. For example, the use of polarized plastic sheets can provide sun protection for the face. As another example, the use of transparent plastic sheets may prevent dust and droplets from contaminating the face.

As shown in FIGS. 17-18, some embodiments of the present disclosure provide a VR device, including VR glasses and an interpupillary distance adjustment assembly, the left frame 1 and the right frame 2 are respectively connected to the left eyepiece 43 and the right eyepiece 44 of the VR glasses.

In some embodiments, the left frame 1 and the right frame 2 are connected to the left eyepiece 43 and the right eyepiece 44 through buckle connection or magnetic adsorption, respectively. For the wearer suffering from myopia, after the left frame 1, the right frame 2, and the adjustable clip 3 are installed, the left side myopia glasses and the right myopia glasses may be connected to the left frame 1 and right frame 2 for installation through the buckle connection, the magnetic adsorption, etc.

In some embodiments, when the interpupillary distance adjustment assembly is used in conjunction with the VR glasses, the wearer may select an appropriate interpupillary distance adjustment assembly based on actual needs, and install the left frame 1 with the left eyepiece 43 of the VR glasses (for example, install through magnetic adsorption, buckle connection, etc.), install the right frame 2 with the right eyepiece of the VR glasses, and then connect the adjustable clip 3 with the left frame 1 and the right frame 2, so that the left eyepiece and the right eyepiece may be fixed, which can make the VR glasses obtain the same interpupillary distance as the interpupillary distance adjustment assembly and adapt to the wearer. When other wearers need to wear the VR glasses, they only need to select a suitable adjustable clip 3, and then replace the adjustable clip 3 on the VR glasses (with the interpupillary distance adjustment assembly installed).

It should be understood, when merchants (such as VR experience halls) use the VR device provided by some embodiments of the present disclosure, they may provide a pair of VR glasses with more than two interpupillary distance adjustment assemblies, one of the interpupillary distance adjustment assemblies may be installed with the VR glasses, and the other one is used for the user to try on to select the suitable adjustable clip 3. After the customer selects the suitable adjustable clip 3, the adjustable clip 3 may be directly installed on the left frame 1 and the right frame 2 of the VR glasses.

In some implementations of the present disclosure, the interpupillary distance adjustment assembly may be installed on existing VR glasses in a way that is more suitable for the wearer’s actual usage habits and interpupillary distance, which can also meet the wearing requirements of ordinary wearers and wearers with myopia. In addition, the manner of installing the myopia glasses after adjusting the left and right frames can avoid the wear and tear on the lenses of the myopia glasses caused by the adjustment process.

FIG. 23 is a schematic diagram of an adjustment unit according to some embodiments of the present disclosure.

In some embodiments, the adjustable clip 3 may include a connection portion and an adjustment portion.

The connection portion refers to a part where the adjustable clip 3 is used to connect the left and right frames. In some embodiments, the connection portion is located on both sides of the adjustment portion, and is used to detachably connected to the left frame 1 and the right frame 2.

In some embodiments, the structure of the connection portion is not limited, as long as it can be detachably connected to the left and right frames. For example, when a groove is designed on the end surface of the left and right frames facing the connecting portion, the connecting portion may be designed as a projection matched with the groove, so as to realize the detachable connection between the connection portion and the left and right frames. For more information on the adjustable clip, left frame, and right frame, please refer to FIGS. 1-22 and related descriptions thereof.

The adjustment portion refers to a core assembly in the adjustable clip 3. As shown in FIG. 23, the cross-sectional shape of the adjusting portion 300 is C-shaped (such as inverted C-shaped), and the adjusting portion 300 has an abdicate cavity 310 to form a cavity for the nose of a wearer, which can increase wearing comfort.

In some embodiments, the adjustment portion 300 includes a rigid unit 320, a deformation connection unit 330, and a horizontal unit 340.

In some embodiments, the cross-section of the adjustment portion 300 is an inverted C-shape, which means that the cross-sectional shape from the front side to the rear side of the adjustment portion 300 is an inverted C-shape. It should be noted that, in the state of wearing the VR glasses, the front of the wearer is the front side, the rear is the rear side, the upper is the upper side, and the lower is the lower side.

The abdicate cavity 310 refers to a cavity structure formed by each structural unit of the adjustment portion 300 based on its shape. In some embodiments, the abdicate cavity 310 may be formed based on a connection of the rigid unit 320 and the horizontal unit 340 through the deformation connection unit 330 to adapt to the shape of the nose bridge of the wearer.

The rigid unit 320 may be a main element of the adjustment portion 300. In some embodiments, the rigid unit 320 is not easily deformed when heated, so the material of the rigid unit 320 may be metal material, thermosetting plastic, or the like.

In some embodiments, the rigid unit 320 is disposed on a side of the abdicate cavity 310 and connected to the horizontal unit 340 through the deformation connection unit 330 for supporting the horizontal unit 340.

In some embodiments, the rigid unit 320 may include a plurality of rigid members, and the specific count may be determined based on simulations, experiments, or the like.

The deformation connection unit 330 refers to an element for connecting the rigid unit 320 and the horizontal unit 340 and connecting two adjacent rigid units 320. In some embodiments, the deformation connection unit 330 is easily deformed when heated, so the deformable connection unit 330 may be made of a thermoplastic material (such as polyethylene) or a composite material of a metal material and a thermoplastic material (such as polyethylene wrapping fine steel wires), or the like.

In some embodiments, the deformation connection unit 330 may also include a plurality of deformation connection members, and the specific count may be determined based on the count of members included in the rigid unit 320 and the horizontal unit 340.

In some embodiments, the shape of the adjustment portion 300 may be adjusted to adjust its width based on the fact that the deformation connection unit 330 is easily deformed when heated. For specific contents of adjusting the width of the adjusting portion, please refer to FIG. 24 and related descriptions thereof.

The horizontal unit 340 refers to an element in a horizontal direction of the adjustment portion 300. In some embodiments, the horizontal unit 340 is disposed on the top surface of the abdicate cavity 310 (such as the side facing the nose bridge of the user), and is connected to the rigid unit 320 through the deformation connection unit 330 to form the abdicate cavity 310.

In some embodiments, the horizontal unit 340 may include at least one horizontal member, and the specific count may also be determined based on experiments, simulations, or the like.

In some embodiments, the structures of the rigid unit 320, the deformation connection unit 330, and the horizontal unit 340 are not limited, and the cross-sectional shape of each unit may be circular, elliptical, or rectangular.

In some embodiments, the adjustment portion 300 may have various structures based on different counts of members included in the rigid unit 30, the deformation connection unit 330, and the horizontal unit 340. As shown in FIG. 23, the adjustment portion 300 may be formed by enclosing upper and lower layer structures, and the cross-sectional shape of the adjustment portion 300 is C-shaped. Specifically, the upper layer structure may be constructed based on a horizontal member being symmetrically connected to four rigid members sequentially through four deformation connection members; the lower layer structure may be formed based on a horizontal member being symmetrically connected to two rigid members through two deformation connection members. The upper layer structure refers to a structure away from an alar end; and the lower layer structure refers to a structure near the alar end.

In some embodiments, the adjustment portion 300 may also have other structures. For example, both the upper and lower layer structures of the adjustment portion 300 may be structures formed by symmetrically connecting a horizontal member to two rigid members through two deformable connection members, that is, the upper layer structure and the lower layer structure are symmetrical structures.

In some embodiments, based on the fact that the deformation connection unit 330 is easily deformed when heated, the width adjustment of the adjustment portion 300 may be realized by adjusting an opening angle of a left end portion and a right end portion of the adjustment portion 300 (or a distance between left and right ends of the abdicate cavity 310).

In some embodiments of the present disclosure, the rigid unit and the horizontal unit are connected through the deformation connection unit to form the abdicate cavity, which can make the adjustment portion more suitable for the shape of the nose bridge of the wearer. Moreover, the width of the adjustment portion may be adjusted because the deformation connection unit is easy to deform when heated.

FIG. 24 is a schematic diagram of an adjustment module according to some embodiments of the present disclosure.

In some embodiments, a VR device may include an adjustment module.

The adjustment module refers to a module for adjusting the width of the adjustment portion. In some embodiments, the adjustment module 400 may be integrated into the VR device, or separately from the VR device, which is not limited in the present disclosure.

As shown in FIG. 24, the adjustment module 400 may include a controller. The adjustment module 400 may also include an interface assembly, a cover assembly 410, a frame assembly 420, and a driving device communicated with the controller.

The controller refers to an assembly used to control an operation of the adjustment module 400. For example, the controller may be a Central Processing Unit (CPU) controller, a microprogram controller, or the like.

In some embodiments, the controller may control the driving device to work based on a width adjustment value, and then drive a left push rod and a right push rod to slide. For specific descriptions of the above content, refer to the related descriptions in the following text.

The interface assembly refer to a related assembly that may be used for communication connections. For example, the interface assembly may be a standard serial port, an Ethernet interface, a Universal Serial Bus (USB) interface, or the like.

The communication connection may be used for data transmission to enable information transfer between different devices or assemblies. In some embodiments, the manner of the communication connection may be a wired connection (e.g., Ethernet, USB, etc.), or a wireless connection (e.g., Bluetooth, WIFI, etc.), which is not limited in the present disclosure.

In some embodiments, the interface assembly may also be used to send the width adjustment value of the adjustment portion 300 to the controller, so that the controller controls the driving device to work. For specific descriptions of the above content, refer to the related descriptions in the following text.

The cover assembly 410 may be used to heat the deformation connection unit 330 of the adjustment portion 300. In some embodiments, the cover assembly 410 may include heating elements, such as electric heating tubes, electric heating coils, or the like. In some embodiments, the cover assembly 410 may also be an element that generates heat by itself, such as an electric heating plate.

In some embodiments, the cover assembly 410 may heat the deformation connection unit 330 of the adjustment portion 300 after the interface assembly (such as a USB interface) is connected to the VR glasses. It should be understood that the VR glasses at this moment are equivalent to a power supply, and are used to supply power to the cover assembly 410.

In some embodiments, the cover assembly 410 may include two covers (i.e., an Upper cover and a lower cover), which are respectively disposed on the front side and the rear side of the adjustment portion 300, so as to completely cover the deformation connection unit 330 of the adjustment portion 300, thereby fully heating the adjustment portion 300 to make the deformation connection unit 330 of the adjustment portion 300 more likely to be deformed, and further the width of the adjustment portion 300 may be adjusted more easily.

The frame assembly 420 is a core assembly of the adjustment module 400. In some embodiments, the frame assembly 420 may include an upper slide rail 421, a lower slide rail 422, a left push rod 423, a right push rod 424, a vertical rod 425, and a horizontal clamp 426.

In some embodiments, both ends of the left push rod 423 and the right push rod 424 are slidingly connected to the upper slide rail 421 and the lower slide rail 422, respectively, and the left push rod 423 and the right push rod 424 are respectively connected to the left end portion and the right end portion of the adjustment portion. In some embodiments, the adjustment portion 300 may be detachably connected to the connection portion, and the left push rod 423 and the right push rod 424 may also be respectively used to connect to the connection portions on both sides of the adjustment portion 300.

The left push rod 423 and the right push rod 424 refer to rods respectively connected to the connection portions at the left and right ends of the adjustable clip 3 and used to push the adjustment portion 300 to slide.

The upper slide rail 421 and the lower slide rail 422 refer to structures that are respectively slidingly connected to the two ends of the left and right push rods.

Sliding connection refers to a connection manner in which two mechanical structures are in contact and may slide (slide towards each other or slide in an opposite direction) between the two. In some embodiments, projections may be provided at both ends of the left push rod 423 and the right push rod 424, and corresponding grooves may be provided on the upper slide rail 421 and the lower slide rail 422 to realize the sliding connection. In some embodiments, the sliding connection may also be implemented in other ways, which is not limited in the present disclosure.

In some embodiments, two ends of the vertical rod 425 are respectively fixed on the upper slide rail 421 and the lower rail 422, the horizontal clamp 426 is slidingly provided on the vertical rod 425, and the horizontal clamp 426 is used to fix the adjustment portion 300 of the horizontal unit 340 to maintain horizontal of the horizontal unit 340.

The vertical rod 425 refers to a rod whose two ends are fixedly connected between the upper and lower slide rails. Specifically, both ends of the vertical rod 425 may be fixedly connected to middle locations of the upper slide rail 421 and the lower slide rail 422. The fixed connection includes a detachable connection (for example, buckle connection, etc.) and a non-detachable connection (for example, welding, etc.).

The horizontal clamp 426 refers to a structure for fixing the horizontal unit 340 of the adjustment portion 300. In some embodiments, the horizontal clamp 426 may be designed in various structures, and it only needs to be able to fix the horizontal unit 340 of the adjustment portion 300. For example, the horizontal clamp 426 may be designed as a buckle structure, or the like.

In some embodiments of the present disclosure, by setting the horizontal clamp on the vertical rod to fix the horizontal unit, the adjustment portion can always keep the horizontal unit in a horizontal state when adjusting the width, thereby effectively ensuring the comfort when the adjustment clip is worn.

The driving device refers to a part used to drive the left and right push rods to slide. In some embodiments, the drive assembly includes, but is not limited to, an electric cylinder, or the like.

In some embodiments, the driving device may be used to drive the left push rod 423 and the right push rod 424 to slide along the upper slide rail 421 and the lower slide rail 422. For example, when the width of the adjustment portion 300 needs to be increased, the driving device may drive the left push rod 423 and the right push rod 424 to slide in opposite directions simultaneously (that is, to slide in a direction away from the vertical rod 42. When the width of the adjustment portion 300 needs to be reduced, the driving device may drive the left push rod 423 and the right push rod 424 to slide relative to each other (that is, to slide in a direction close to the vertical rod 425).

In some embodiments, the driving device may drive the left and right push rods to slide based on various ways. For example, the driving device may be directly connected to the left and right push rods for driving. As another example, the driving device may drive the left and right push rods based on a connection between a transmission mechanism and the left and right push rods.

In some embodiments, the VR glasses may also include a processor.

The processor may process data and/or information obtained from other devices or assemblies of an apparatus. The processor may execute program instructions based on the aforementioned data, information and/or processing results to perform one or more functions described in the present disclosure. In some embodiments, the processor 120 may include one or more sub-processing devices. For example, the processor may include a Central Processing Unit (CPU), a microprocessor, or the like.

In some embodiments, the processor may be configured to determine a width adjustment value of the adjustment portion 300 based on user feedback; send the width adjustment value to the controller of the adjustment module 400 through the interface assembly, and control the driving device to drive the sliding of the left push rod 423 and the right push rod 424 according to the width adjustment value based on the controller.

The user feedback refers to the wearer’s feedback on the experience of using the VR glasses. For example, the user feedback may be an image clarity degree, or the like.

In some embodiments, the user feedback may be the user experience feedback when using the VR glasses with both eyes, or the user experience feedback (e.g., user left eye feedback or user right eye feedback) when using the VR glasses with one eye (such as the left eye or the right eye).

In some embodiments, user feedback may include user left eye feedback and user right eye feedback. It should be understood that due to factors such as the different eyesight of the wearer’s left and right eyes, there may be some differences between the user left eye feedback and user right eye feedback. Therefore, based on the user left eye feedback and user right eye feedback, the real experience of the user can be more accurately fed back, so as to lay a foundation for determining the width adjustment value of the adjustment portion.

In some embodiments, the processor may obtain the user feedback based on various manners. For example, the user feedback may be obtained based on an external input device (e.g., a handle, etc.).

In some embodiments, the processor may divide a binocular field of view of the VR glasses into a plurality of sub-regions based on a preset manner; display preset images sequentially in the plurality of sub-regions, and sequentially obtain the user feedback; and determine the width adjustment value of the adjustment portion 300 based on the user feedback.

The binocular field of view of the VR glasses may be understood as a size of an image displayed by VR glasses.

The preset manner refers to a preset region division manner. For example, the preset manner may include, but not limited to, uniformly divide a region where the binocular field of view of the VR glasses is located into grids, or the like.

Further, when the region where the binocular field of view of the VR glasses is located is uniformly divided into grids, a plurality of grid regions may be obtained, that is, a plurality of sub-regions may be obtained. And the plurality of sub-regions may be expressed based on coordinates, for example, (Aₘ, Bₙ) is expressed as a sub-region which is located at m-th row and n-th column.

In some embodiments, the specific manner of dividing the grids (e.g., a grid size) may be determined based on experiments, simulations, etc., so as to optimize an appropriate grid size to ensure the reliability of the data fed back by the user.

The preset image refers to a preset image used for display by the VR glasses.

In some embodiments, the processor may sequentially display the preset images in the plurality of sub-regions, and obtain the user feedback sequentially. Specifically, when a sub-region displays a preset image, the wearer (that is, the user) may give the feedback on the clarity degree of the preset image displayed in the sub-region. The user feedback may be obtained sequentially as the sub-regions sequentially display the preset images from upper to lower and from left to right.

It can be understood that there may be various sequences in which the preset images are displayed in the sub-regions, such as a “S” shape, or the like.

The width adjustment value refers to a sliding distance when the driving device drives the left and right push rods to slide.

In some embodiments, based on user feedback, there may be various ways to determine the width adjustment value of the adjustment portion 300. For example, the processor may construct a comparison table based on the user feedback and the width adjustment value, and determine the width adjustment value by looking up the comparison table.

In some embodiments, the processor may also process the user feedback into a preset format to obtain a feedback feature; and determine the width adjustment value by processing the feedback feature based on the width adjustment model.

The preset format refers to a preset format for expressing the user feedback. For example, the preset format may include a vector form, or the like.

In some embodiments, the processor may process the user feedback into the preset format based on various manners. For example, based on the user feedback from six sub-regions from left to right and from upper to lower, the processor may indicate the preset image displayed in the sub-region where the user feedback is located not clear as 0, and the preset image displayed in the sub-region clear as 1. The vector of the user feedback is obtained as (1, 0, 0, 1, 1, 0), that is, the feedback feature is (1, 0, 0, 1, 1, 0); or the vector of the user’s left eye is (1, 0, 0, 1, 1, 0), the vector of the user’s right eye is (1, 1, 0, 1, 1, 0), that is, the feedback feature of the left eye is (1, 0, 0, 1, 1, 0), and the feedback feature of the right eye is (1, 1, 0, 1, 1, 0).

The width adjustment model refers to a model used to determine the width adjustment value. In some embodiments, the width adjustment model may be a machine learning model. For example, the width adjustment model may be a Convolutional Neural Networks (CNN) model, a Graph Neural Network (GNN) model, or other custom models.

In some embodiments, an input of the width adjustment model may include the feedback feature, and an output may include the width adjustment value.

In some embodiments, the output of the width adjustment model may include a plurality of different width adjustment values to adapt to different application scenes of the VR device. For example, in some application scenes, the wearer pays more attention to the near view and central vision, while in some application scenes, the wearer pays more attention to the wider field of view.

For example, the output of the width adjustment model may be a sequence (such as a vector) composed of the plurality of different width adjustment values, and each element location in the sequence corresponds to an application scene. The width adjustment values of the VR device in different application scene may be determined based on the width adjustment value at each element location. The corresponding relationship between the element location in the sequence and the application scene may be preset in advance.

In some embodiments, the processor may build a matching table based on historical data for different application scenes of the VR device (that is, the different application scenes correspond to different width adjustment value ranges), and look up the matching table to select a width adjustment value suitable for a corresponding application scene of the VR device from the above-mentioned different width adjustment values.

In some embodiments, the processor may also optimize the width adjustment value suitable for the corresponding application scene of the VR device based on other manners. For example, the width adjustment value may be determined based on vector retrieval, etc.

In some embodiments, training samples of the width adjustment model may include sample feedback features. In some embodiments, the training samples may be obtained based on historical data.

In some embodiments, a label of the training sample may be an actual width adjustment value of a sample adjustment portion. In some embodiments, the label may be obtained based on manual labeling and other manners. In some embodiments, the output of the width adjustment model includes different width adjustment values, so the labels of the training samples may include a plurality of actual width adjustment values of the sample adjustment portion in the different application scenes.

In some embodiments, the width adjustment model may be obtained through training. For example, the sample feedback feature may be input into an initial width adjustment model to obtain a width adjustment value output by the initial width adjustment model, and then the value of a loss function may be determined based on a difference between the label and the width adjustment value output by the initial width adjustment model, and a trained width adjustment model is obtained.

It should be understood that the output of the width adjustment model includes different width adjustment values, so when the width adjustment model is trained, the labels corresponding to different application scenes are also different, which can train the model more specifically, so that it can be effectively ensure the accuracy of the prediction results of the width adjustment model.

In some embodiments, the connection portion of the adjustable clip 3 may be connected to the left frame 1 and the right frame 2, respectively. When the user wears the VR glasses, the processor may obtain the user feedback based on the VR glasses, then take out the adjustable the clip 3 from the left frame 1 and the right frame 2, and fix the horizontal unit 340 of the adjustment portion 300 in the horizontal clamp 426 of the adjustment module 400. The processor may also connect the left end portion and the right end portion of the adjustment portion 300 respectively to the left push rod 423 and right push rod 424 of the adjustment module 400, then connect the adjustment module 400 to the VR glasses through the interface assembly (such as the USB interface, etc.), and then heat the deformation connection unit 330 of the adjustment portion 300 by the cover assembly 410. After heating for a time period, the processor may obtain the user feedback based on the VR glasses, determine the width adjustment value of the adjustment portion 300, and send the width adjustment value to the controller through the interface assembly. The controller controls the driving device to drive the left push rod 423 and the right push rod 424 to slide (slide towards each other or in the opposite direction) according to the width adjustment value. When an actual sliding distance of the left push rod 423 and right push rod 424 is consistent with the width adjustment value, the driving device may be controlled to stop, and the left push rod 423 and the right push rod 424 may stop sliding. Finally, the adjustable clip 3 after the width adjustment is completed is taken out from the adjustment module 400, and installed back into the VR glasses for use.

In some embodiments of the present disclosure, the width of the adjustment portion is adjusted by setting the adjustment module, so that the width of the adjustable clip may be adjusted, then the VR glasses can meet the actual needs of wearers with different interpupillary distances, and the VR glasses can be applied to different application scenes. In addition, by dividing the binocular field of view of VR glasses into the plurality of sub-regions, obtaining user feedback sequentially, and determining the width adjustment value through the width adjustment model, the accuracy of the width adjustment value can be effectively guaranteed, which is beneficial to improving the user experience of the VR glasses.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. An interpupillary distance adjustment assembly, comprising a left frame and a right frame, wherein an adjustable clip with an adjustable width is provided between the left frame and the right frame, and the adjustable clip is detachably connected to the left frame and the right frame, respectively.

2. The interpupillary distance adjustment assembly according to claim 1, wherein the adjustable clip is detachably connected to the left frame and the right frame through a matching structure of a protrusion and a groove.

3. The interpupillary distance adjustment assembly according to claim 2, wherein a limiting structure is provided between the protrusion and the groove; and the limiting structure includes a limiting cavity and a protruding portion matched with the limiting cavity.

4. The interpupillary distance adjustment assembly according to claim 1, wherein for each frame of the left frame and the right frame, an opaque coverd is detachably provided on the frame, and a small hole is provided in a middle of the opaque cover.

5. The interpupillary distance adjustment assembly according to claim 4, wherein at least one first protruding hull protruding outward is provided on an edge of the frame, and the opaque cover is provided with a second protruding hull matched with the first protruding hull, and a magnetic adsorption part is placed in the first protruding hull and the second protruding hull; and the edge of the frame is also provided with a blocking rib.

6. The interpupillary distance adjustment assembly according to claim 5, wherein the edge of the frame is further provided with a third protruding hull protruding outward for connecting to an external lens.

7. The interpupillary distance adjustment assembly according to claim 5, wherein an outer wall of the frame is provided with a connecting block protruding outward, and the connecting block is provided with a through hole, the adjustable clip includes a connecting rod, two ends of the connecting rod are provided with a support leg, and the support leg is inserted into the through hole.

8. The interpupillary distance adjustment assembly according to claim 4, wherein an installation groove is provided on an inner ring of the frame opposite to a side where the opaque cover is installed, and an inner wall of the installation groove is provided with a limiting protruding rib.

9. The interpupillary distance adjustment assembly according to claim 1, wherein a front end or a rear end of the left frame or the right frame is provided with a detachable additional frame.

10. The interpupillary distance adjustment assembly according to claim 9, wherein the front end or the rear end of the left frame or the right frame is provided with a magnetic adsorption part by setting a first installation groove; and the additional frame is provided with another magnetic adsorption part by setting a second installation groove corresponding to the first installation groove.

11. The interpupillary distance adjustment assembly according to claim 10, wherein the left frame or the right frame is provided with at least one fourth protruding hull on an edge of the frame, and the first installation groove is provided on the fourth protruding hull.

12. The interpupillary distance adjustment assembly according to claim 10, wherein an edge of the left frame or the right frame is provided with an arc-shaped blocking rib extending backward or forward.

13. The interpupillary distance adjustment assembly according to claim 10, wherein an isolation baffle is provided between the left frame and the additional frame, and between the right frame and the additional frame.

14. VR glasses, comprising a VR glasses body and the interpupillary distance adjustment assembly according to claim 4, wherein the left frame and the right frame are detachably connected to a left eyepiece and a right eyepiece of the VR glasses, respectively, for the left frame and the left eyepiece, or for the right frame and the right eyepiece, the small hole on the opaque cover and an optical center on the eyepiece of the VR glasses body are located on a same straight line, and the straight line is perpendicular to the opaque cover and the eyepiece.

15. A VR device, comprising VR glasses and the interpupillary distance adjustment assembly according to claim 1, wherein the left frame and the right frame are detachably connected to a left eyepiece and a right eyepiece of the VR glasses, respectively.

16. The VR device according to claim 15, wherein the adjustable clip includes a connection portion and an adjustment portion, the connection portion is located on both sides of the adjustment portion, and the connection portion is used to realize a detachable connection between the adjustable clip and the left frame, and between the adjustable clip and the right frame; and
a cross-section of the adjustment portion is a C-shaped cross-section, the adjustment portion is provided with an abdicate cavity, the adjustment portion includes a rigid unit, a deformation connection unit, and a horizontal unit, the rigid unit and the horizontal unit are connected through the deformation connection unit to form the abdicate cavity, the horizontal unit is located on a top surface of the abdicate cavity, and the rigid unit is located on a side of the abdicate cavity.

17. The VR device according to claim 16, further comprising an adjustment module, wherein the adjustment module includes a controller, the adjustment module further includes an interface assembly, a cover assembly, a frame assembly, and a driving device respectively communicated with the controller;
the frame assembly includes an upper slide rail, a lower slide rail, a left push rod, a right push rod, a vertical rod, and a horizontal clamp;
both ends of the left push rod and the right push rod are slidingly connected to the upper slide rail and the lower slide rail, respectively, and the left push rod and the right push rod are respectively connected to a left end portion and a right end portion of the adjustment portion;
both ends of the vertical rod are respectively fixed on the upper slide rail and the lower rail, the horizontal clamp is slidingly provided on the vertical rod, and the horizontal clamp is used to fix the horizontal unit of the adjustment portion to maintain horizontal of the horizontal unit; and
the interface assembly is used to connect the VR glasses, the cover assembly is used to heat the deformation connection unit of the adjustment portion, and the driving device is used to drive a sliding of the left push rod and the right push rod.

18. The VR device according to claim 17, wherein the VR glasses include a processor configured to:
determine a width adjustment value of the adjustment portion based on user feedback; and
send the width adjustment value to the controller of the adjustment module through the interface assembly, and control the driving device to drive the sliding of the left push rod and the right push rod according to the width adjustment value based on the controller.

19. The VR device according to claim 18, wherein the processor is further configured to:
divide a binocular field of view of the VR glasses into a plurality of sub-regions based on a preset manner;
display preset images sequentially in the plurality of sub-regions, and sequentially obtain the user feedback; and
determine the width adjustment value of the adjustment portion based on the user feedback.

20. The VR device according to claim 19, wherein the processor is further configured to:
obtain a feedback feature by processing the user feedback into a preset format; and
determine the width adjustment value by processing the feedback feature based on a width adjustment model, the width adjustment model being a machine learning model.
